(19) United States
(12) Patent Application Publication
(10) Pub. No.: US 2026/0322025 A1
(43) Pub. Date: Oct. 15, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Xingke YANG, Mie (JP)

(21) Appl. No.: 19/484,356

(22) PCT Filed: May 13, 2024
(86) PCT No.: PCT/JP2024/017638

§ 371 Date: Nov. 14, 2025

(30) Foreign Application Priority Data
May 23, 2023 (JP) 2023-084295

(51) Int. Cl. H01R 13/506

(52) U.S. Cl. CPC H01R 13/506

(57) ABSTRACT

A connector (10) comprises an accommodating member (31) that accommodates a female terminal fitting (33), and a cover member (32) that covers the female terminal fitting (33) accommodated by the accommodating member (31). The accommodating member (31) has a locking part (31J), and the cover member (32) has a locked part (32D) to which the locking part (31J) is locked. The locking part (31J) is elastically deformed in a downward direction (prescribed direction) by the locked part (32D), elastically restored, and then locked to the locked part (32D). The cover member (32) has a restricting part (32G). In a state in which the locking part (31J) is elastically deformed in the downward direction (prescribed direction) by the locked part (32D), the restricting part (32G) restricts the cover member (32) from separating from the accommodating member (31) in an upward direction opposite to the downward direction (prescribed direction).

### TECHNICAL FIELD

The present disclosure relates to a connector.

### BACKGROUND

In a connector disclosed in Patent Document 1, the deformation of a terminal unit projecting backward from a connector housing is suppressed by mounting a displacement restricting member.

### PRIOR ART DOCUMENT

### Patent Document

Patent Document 1: JP 2019-114334 A

### SUMMARY OF THE INVENTION

### Problems to be Solved

In the configuration of Patent Document 1, the displacement restricting member is separately provided and the number of components is increased.

The present disclosure was developed on the basis of the above situation and aims to provide a technique capable of suppressing the deformation of a connector by a simple configuration.

### Means to Solve the Problem

The present disclosure is directed to a connector with an accommodating member for accommodating a terminal fitting and a covering member for covering the terminal fitting accommodated in the accommodating member, the accommodating member including a locking portion, the covering member including a locked portion to be locked by the locking portion, the locking portion being configured to be resiliently deformed in a predetermined direction by the locked portion, resiliently return and lock the locked portion, the covering member including a restricting portion, and the restricting portion restricting separation of the covering member from the accommodating member in a direction opposite to the predetermined direction with the locking portion resiliently deformed in the predetermined direction by the locked portion.

### Effect of the Invention

According to the present disclosure, the deformation of a connector can be suppressed by a simple configuration.

### BRIEF DESCRIPTION OF THE DRAWINGS

FIG. 1 is an exploded perspective view showing a connector of one embodiment.

FIG. 2 is a perspective view of an accommodating member when viewed from a left upper side.

FIG. 3 is a perspective view of the accommodating member when viewed from a right lower side.

FIG. 4 is a partial enlarged plan view showing the accommodating member.

FIG. 5 is a partial enlarged side view of the accommodating member.

FIG. 6 is a perspective view of the accommodating member when viewed from a left lower side.

FIG. 7 is a perspective view of a covering member when viewed from the left lower side.

FIG. 8 is a perspective view of the covering member when viewed from the right lower side.

FIG. 9 is a plan view in section showing a mating housing.

FIG. 10 is a side view showing the connector in a state where the covering member is arranged at a second position.

FIG. 11 is a section along A-A in FIG. 10.

FIG. 12 is a section along B-B in FIG. 10.

FIG. 13 is a side view showing the connector in a state where the covering member is arranged at a first position.

FIG. 14 is a plan view showing a state where the connector is inserted in a receptacle with the covering member arranged at the second position.

FIG. 15 is a plan view showing a state where the covering member is displaced to the first position with the connector inserted in the receptacle.

### DETAILED DESCRIPTION TO EXECUTE THE INVENTION

### Description of Embodiments of Present Disclosure

First, embodiments of the present disclosure are listed and described.
(1) The connector is provided with an accommodating member for accommodating a terminal fitting and a covering member for covering the terminal fitting accommodated in the accommodating member, the accommodating member including a locking portion, the covering member including a locked portion to be locked by the locking portion, the locking portion being configured to be resiliently deformed in a predetermined direction by the locked portion, resiliently return and lock the locked portion, the covering member including a restricting portion, and the restricting portion restricting separation of the covering member from the accommodating member in a direction opposite to the predetermined direction with the locking portion resiliently deformed in the predetermined direction by the locked portion.

In the connector of (1), by providing the covering member with the restricting portion, the separation of the covering member from the accommodating member by a reaction force is restricted even if the locking portion is resiliently deformed. Thus, the plastic deformation of the covering member can be prevented without increasing components.
(2) In the connector of (1), the covering member is displaceable between a first position and a second position with respect to the accommodating member, the locking portion is configured to be resiliently deformed and resiliently return while the covering member is displaced between the first and second positions, the accommodating member includes a guide portion to be locked by the restricting portion from the predetermined direction side, and the restricting portion constantly maintains a state locked to the guide portion while the covering member is displaced between the first and second positions.

In the connector of (2), the separation of the covering member from the accommodating member can be reliably restricted while the locking portion is resiliently deformed and resiliently returns.
(3) In the connector of (1) or (2), the covering member includes a flat plate-like plate portion facing the accommodating member and a flat plate-like reinforcement wall portion extending in a direction intersecting the plate portion.

In the connector of (3), the deflection of the plate portion can be prevented by reinforcing the plate portion by the reinforcement wall portion.
(4) In the connector of (3), a plate thickness direction of the plate portion is oriented in a vertical direction, a plate thickness direction of the reinforcement wall portion is oriented in a lateral direction, the restricting portion is provided on a lower end of a front end part of the reinforcement wall portion, and the locked portion projects downward from the plate portion and is connected to an upper end of the front end part of the reinforcement wall portion.

In the connector of (4), since the locked portion and the restricting portion are both provided on the front end part of the reinforcement wall portion and the restricting portion is arranged near the locked portion, to which a reaction force of the resiliently deformed locking portion is applied, the separation of the plate portion from the accommodating member can be efficiently restricted.
(5) In the connector of (4), the covering member includes a first wall portion extending long in a front-back direction and hanging down from a right end edge of the plate portion with a plate thickness direction oriented in the lateral direction and a second wall portion extending long in the front-back direction and hanging down from a left end edge of the plate portion with a plate thickness direction oriented in the lateral direction, a length in the front-back direction of the second wall portion is shorter than that of the first wall portion, the first wall portion entirely covers a right side wall portion of the accommodating member in the front-back direction and is locked to the right side wall portion, the second wall portion covers a back side of a left side wall portion of the accommodating member and is locked to the left side wall portion, the locking portion extends in the front-back direction and is arranged side by side with a front part of the second wall portion, and the reinforcement wall portion extends forward from a front end of the second wall portion and is arranged to the right of the locking portion.

In the connector of (5), since the locking portion is provided in a front region of the second wall portion, the second wall portion cannot be engaged with a front side of the left side wall portion of the accommodating member. However, since the reinforcement wall portion extends forward from the front end of the second wall portion and is arranged to the right of the locking portion, the reinforcement wall portion can be arranged to the right of and adjacent to the locking portion and the plate portion (covering member) can be reinforced not to be separated from the accommodating member in a region forward of the second wall portion.

### DETAILS OF EMBODIMENT OF PRESENT DISCLOSURE

### Embodiment

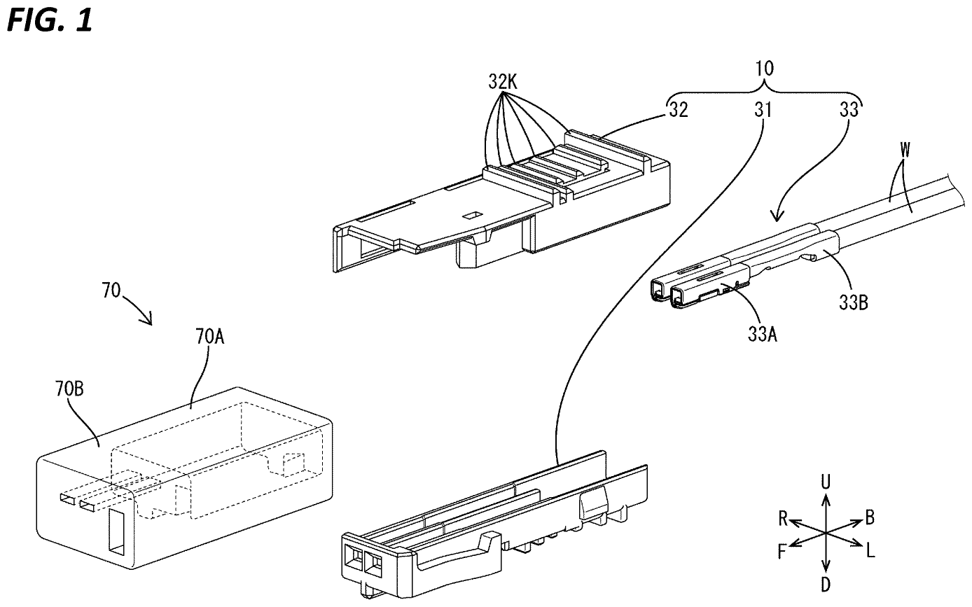

A connector 10 of one specific embodiment of the present disclosure is described with reference to FIGS. 1 to 15. In this embodiment, a “front side”, a “back side”, an “upper side”, a “lower side”, a “right side” and a “left side” are respectively denoted by “F”, “B”, “U”, “D”, “R” and “L”. The connector 10 is a connector for in-vehicle communication. As shown in FIG. 1, the connector 10 is provided with an accommodating member 31, a covering member 32 and female terminal fittings 33. The connector 10 is connected to a mating connector 70. The mating connector 70 includes a receptacle 70A and a back wall portion 70B.

### Configuration of Accommodating Member

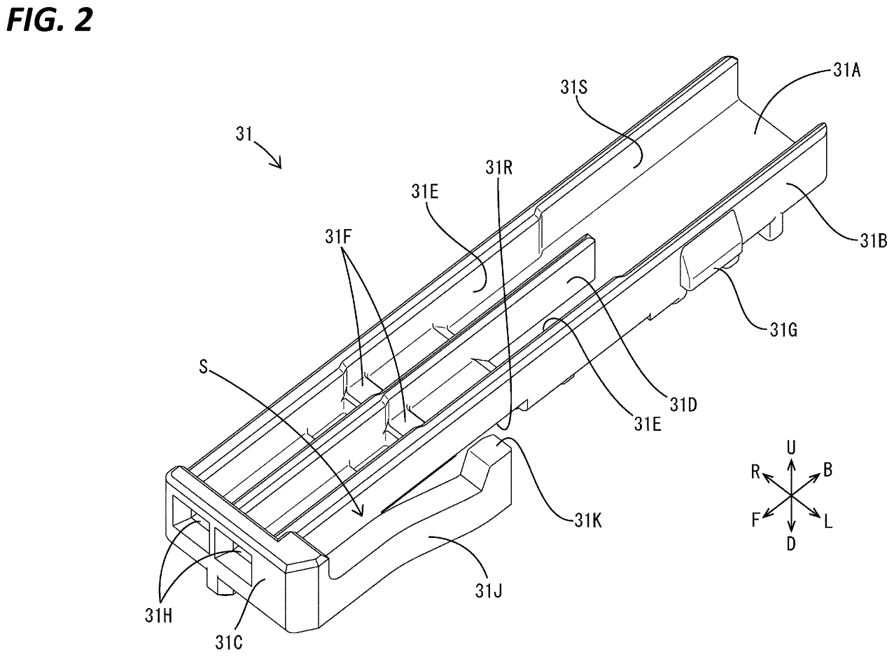

The accommodating member 31 is a dielectric made of synthetic resin. As shown in FIG. 2, the accommodating member 31 is elongated in a front-back direction as a whole and includes a bottom wall portion 31A, a left side wall portion 31B and a right side wall portion 31S rising upward from both left and right side edges of the bottom wall portion 31A, and a front wall portion 31C connected to the front ends of the bottom wall portion 31A and the left and right side wall portions 31B, 31S. A partition wall portion 31D rising upward is formed in a center in a lateral direction of the bottom wall portion 31A. A pair of left and right accommodation chambers 31E defined by the partition wall portion 31D and the left and right side wall portions 31B, 31S and open upward and backward of the accommodating member 31 are formed inside the accommodating member 31. The female terminal fitting 33, which is a terminal fitting to be described later, is accommodated into each accommodation chamber 31E, and a retaining projection 31F for restricting a backward displacement of the female terminal fitting 33 by locking the back end of a box portion 33A of the female terminal fitting 33 is formed on the bottom surface of each accommodation chamber 31E.

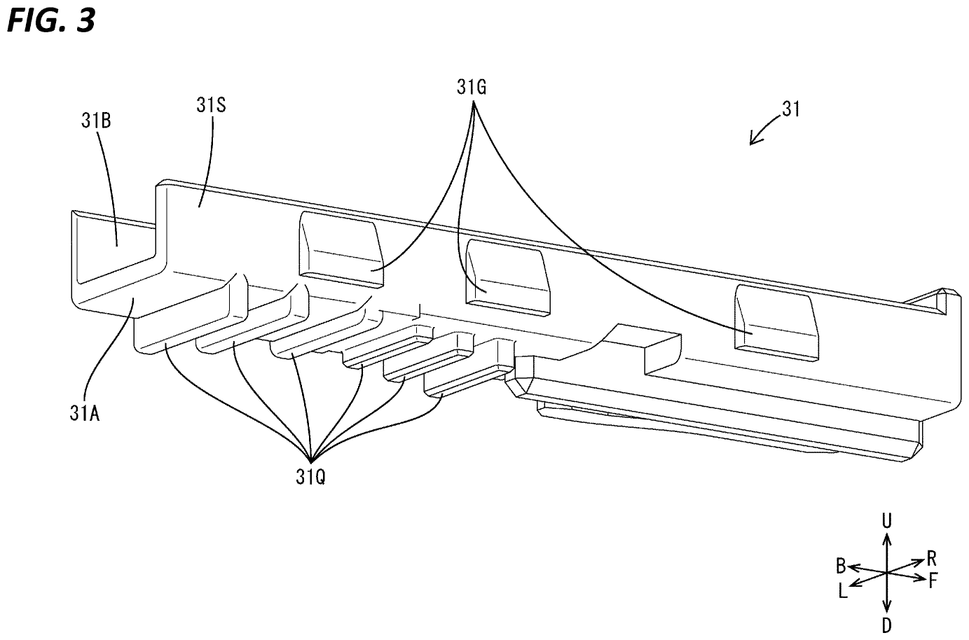

As shown in FIGS. 2 and 3, a plurality of lock projections 31G are provided to project outward in the lateral direction on the outer side surface of each of the left and right side wall portions 31B, 31S. Specifically, three lock projections 31G are provided side by side in the front-back direction on the right side wall portion 31S. One lock projection 31G is provided on the left side wall portion 31B. An upper region of the outer side surface of each lock projection 31G is formed into an inclined surface inclined upward toward a center in the lateral direction. The lower surface of the lock projection 31G perpendicularly extends toward the center in the lateral direction. A plurality of finger placing projections 31Q are provided to project downward on the lower surface of a back side of the bottom wall portion 31A (see FIG. 3). The respective finger placing projections 31Q extend in the lateral direction and are arranged apart from each other in the front-back direction (see FIG. 3).

As shown in FIG. 2, the front wall portion 31C is formed with a pair of left and right through holes 31H penetrating from the front end surface of the accommodating member 31 to the respective accommodation chambers 31E. A mating terminal (not shown) in the form of an elongated tab is inserted into the through hole 31H from front.

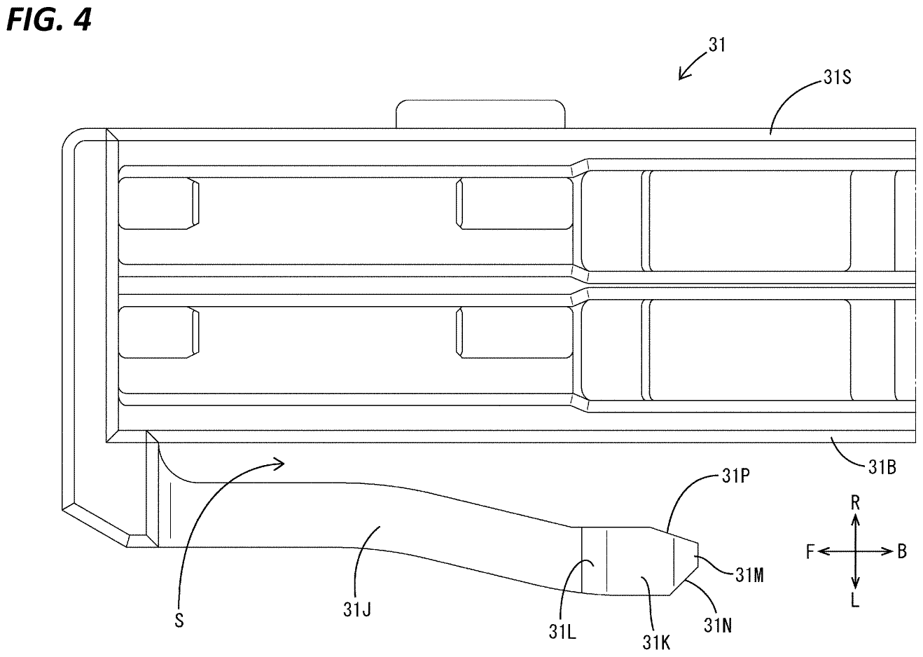

A locking portion 31J is provided on a left end part of the front wall portion 31C. In other words, the accommodating member 31 includes the locking portion 31J. The locking portion 31J is cantilevered backward from the left end part of the front wall portion 31C. The locking portion 31J is formed to extend long in the front-back direction. The locking portion 31J extends backward along the left side wall portion 31B. A back side of the locking portion 31J is inclined to be separated from the left side wall portion 31B toward a left back side. A space between the locking portion 31J and the left side wall portion 31B is formed as an allowance space S, into which the resiliently deformed locking portion 31J can enter. The left and right surfaces in a back end part of the locking portion 31J are formed as a right inclined surface 31P and a left inclined surface 31N inclined toward each other toward a back side (see FIG. 4).

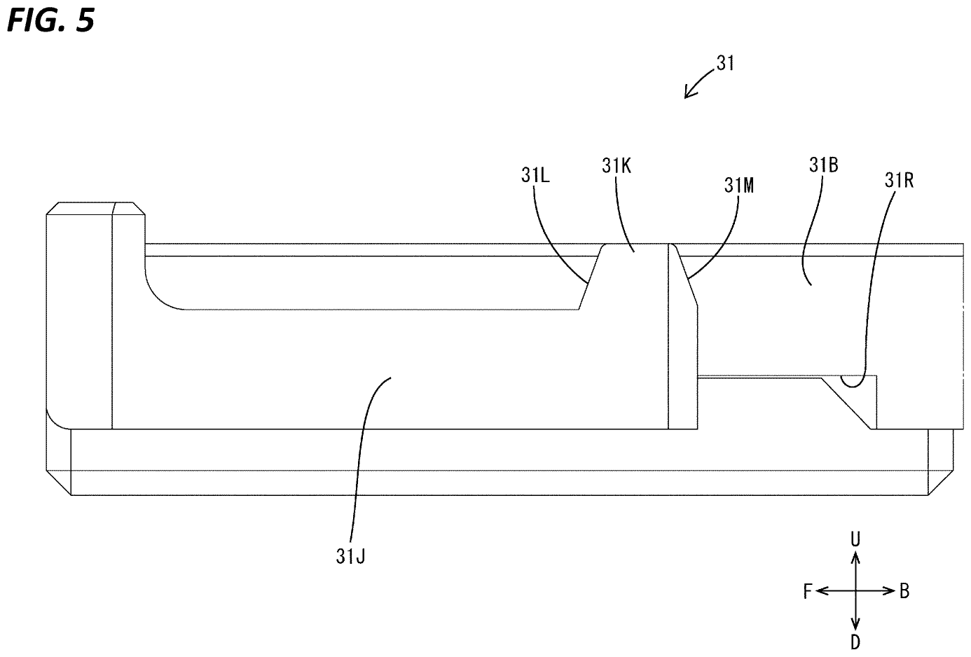

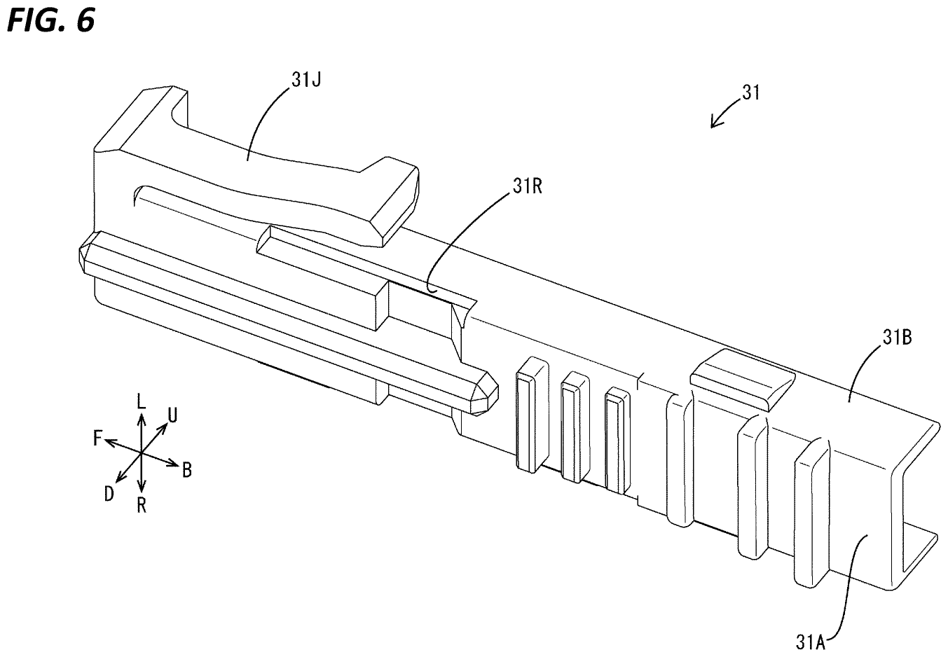

As shown in FIG. 5, a protrusion 31K projecting upward is provided on the back end part of the locking portion 31J. The front and back surfaces of the protrusion 31K are formed as a front inclined surface 31L and a back inclined surface 31M inclined toward each other toward an upper side. As shown in FIG. 6, a guide portion 31R is formed on a lower end edge part where the left side wall portion 31B and the bottom wall portion 31A are connected. In other words, the accommodating member 31 includes the guide portion 31R. The guide portion 31R is formed to be recessed upward and extend in the front-back direction on the lower end edge part where the left side wall portion 31B and the bottom wall portion 31A are connected.

### Configuration of Covering Member

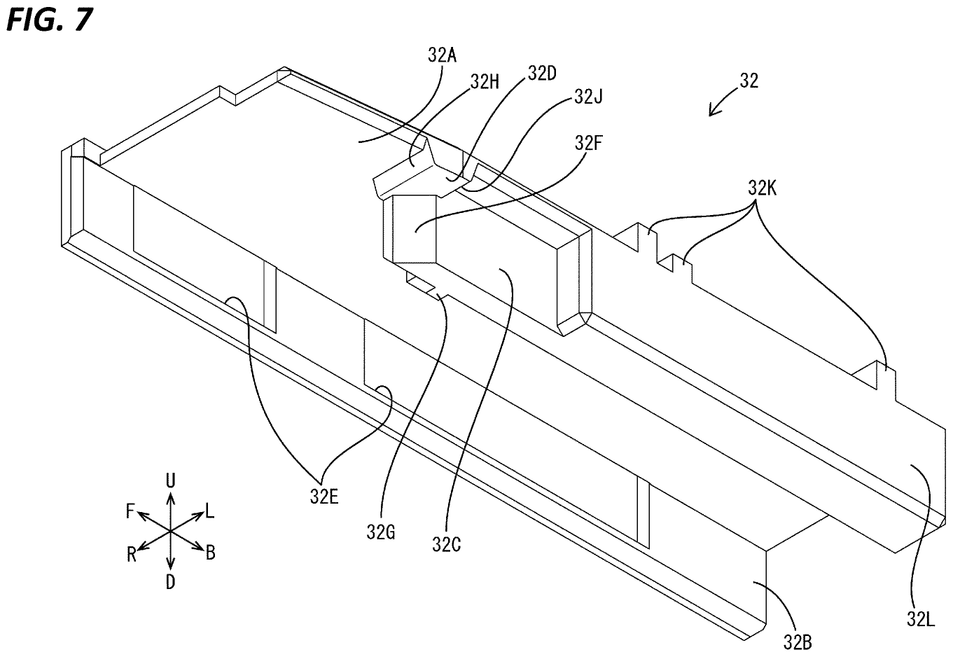

The covering member 32 is a dielectric made of synthetic resin. As shown in FIG. 7, the covering member 32 has a shape elongated in the front-back direction as a whole. The covering member 32 includes a plate portion 32A, a first wall portion 32B, a second wall portion 32L, a reinforcement wall portion 32C and a locked portion 32D. The plate portion 32A is in the form of a flat plate and a plate thickness direction thereof is oriented in a vertical direction. The plate portion 32A is provided with a plurality of finger placing projections 32K projecting upward. The respective finger placing projections 32K extend in the lateral direction and are arranged apart from each other in the front-back direction (see FIG. 1).

The first wall portion 32B extends long in the front-back direction and hangs down from the right end edge of the plate portion 32A with a plate thickness direction oriented in the lateral direction. The first wall portion 32B is connected to the entire right end edge of the plate portion 32A in the front-back direction. The second wall portion 32L extends long in the front-back direction and hangs down from the left end edge of the plate portion 32A with a plate thickness direction oriented in the lateral direction. The front end edge of the second wall portion 32L is located in a central part in the front-back direction of the plate portion 32A. The back ends of the first and second wall portions 32B, 32L are formed to be flush with the back end of the plate portion 32A. That is, a length in the front-back direction of the second wall portion 32L is shorter than that of the first wall portion 32B.

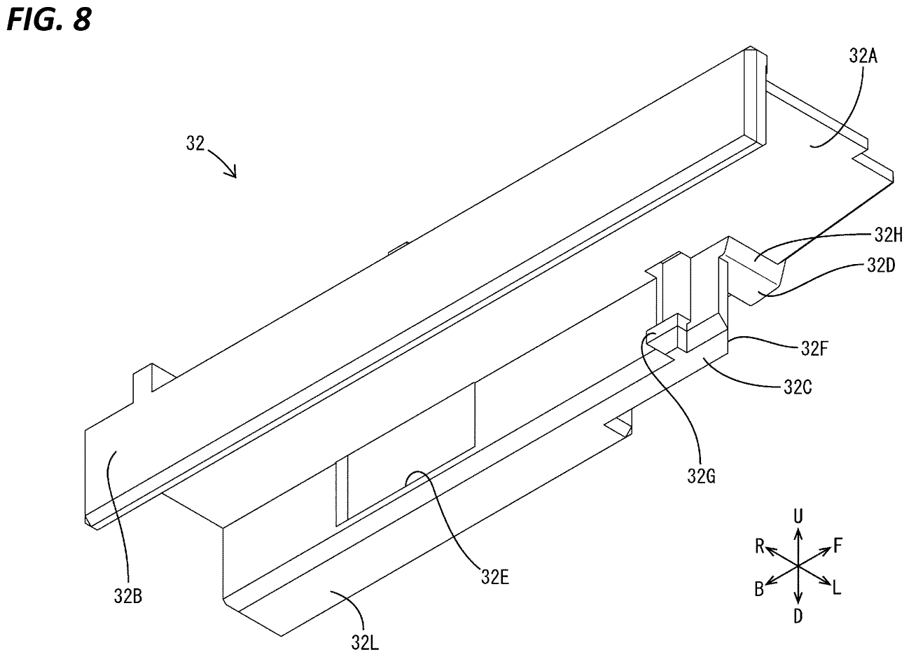

The first and second wall portions 32B, 32L can be resiliently deformed to expand in the lateral direction with the upper end edges (boundary parts with the plate portion 32A) as fulcrums. The inner surfaces of the first and second wall portions 32B, 32L are formed with locking recesses 32E recessed outward in the lateral direction (see FIGS. 7 and 8). The lower end of each locking recess 32E is located above the lower end of each of the first and second wall portions 32B, 32L.

The reinforcement wall portion 32C is in the form of a flat plate hanging down from the lower plate surface (plate surface facing the accommodating member 31) of the plate portion 32A in a direction orthogonal to this plate surface. A plate thickness direction of the reinforcement wall portion 32C is oriented in the lateral direction. The reinforcement wall portion 32C extends forward from the front end of the second wall portion 32L. The left surface of the reinforcement wall portion 32C is located to the right of the left surface of the second wall portion 32L. The right surface of the reinforcement wall portion 32C is flush with the right surface of the second wall portion 32L (see FIG. 8). A front end part of the left surface of the reinforcement wall portion 32C is formed as an inclined surface 32F inclined to a front right side. A restricting portion 32G cantilevered rightward is provided on the lower end of a front end part of the reinforcement wall portion 32C. In other words, the covering member 32 includes the restricting portion 32G.

The locked portion 32D is provided to project downward from the lower plate surface of the plate portion 32A. The locked portion 32D is arranged to be continuous with the upper end of the front end part of the reinforcement wall portion 32C. The locked portion 32D is arranged to extend further leftward than the reinforcement wall portion 32C. The front and back surfaces of the locked portion 32D are formed as a front inclined surface 32H and a back inclined surface 32J inclined toward each other toward an upper side.

### Configuration of Female Terminal Fitting

As shown in FIG. 1, the female terminal fitting 33 has a shape elongated in the front-back direction as a whole. A front end region of the female terminal fitting 33 serves as the box portion 33A in the form of a rectangular tube, to which the mating terminal (not shown) is inserted and conductively connected. The female terminal fitting 33 accommodated in the accommodation chamber 31E is restricted from coming out backward from the accommodating member 31 by locking the box portion 33A by the retaining projection 31F.

A back end region of the female terminal fitting 33 serves as a crimping portion 33B in the form of an open barrel extending backward from the back end of the box portion 33A. The crimping portion 33B is conductively fixed to a front end part of a wire W. Two wires W fixed to two female terminal fittings 33 constitute a twisted pair cable. The twisted pair cable exhibits a shielding function of suppressing electromagnetic noise by spirally twisting the two wires W. Although the two wires W are covered by an outer sheath (not shown), the outer sheath is removed in a front end part of the twisted pair cable to expose the two wires W in an untwisted state. The two female terminal fittings 33 individually fixed to the front end parts of the two wires W are accommodated into the accommodation chambers 31E from above the accommodating member 31.

### Configuration of Mating Connector

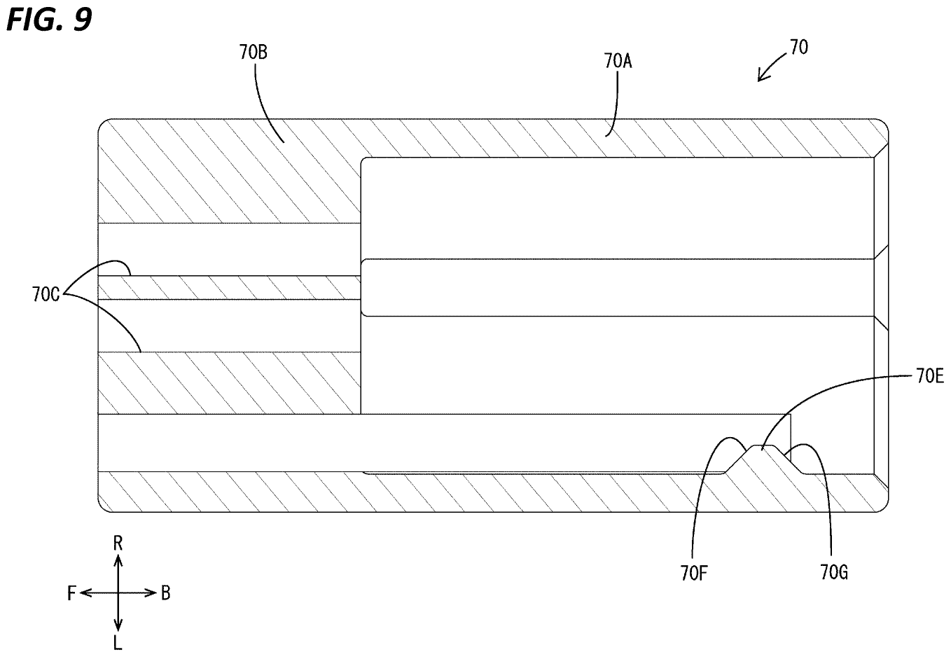

The mating connector 70 is a dielectric made of synthetic resin. As shown in FIG. 1, the mating connector 70 is in the form of a block long in the front-back direction. As shown in FIG. 9, the receptacle 70A is in the form of a rectangular tube extending in the front-back direction. The back end of the receptacle 70A is open backward. A mountain-shaped portion 70E projecting inward in the lateral direction is provided on the inner surface of a left wall portion of the receptacle 70A. The front and back surfaces of the mountain-shaped portion 70E are formed as a front inclined surface 70F and a back inclined surface 70G inclined toward each other toward a right side. The back wall portion 70B is arranged to close the front end of the receptacle 70A. The back wall portion 70B is formed with two insertion holes 70C penetrating in the front-back direction. The tab-shaped mating terminal (not shown) is press-fit into each insertion hole 70C. In this way, the insertion hole 70C holds the press-fit mating terminal in an inserted state.

### Concerning Example of Assembly Procedure of Connector

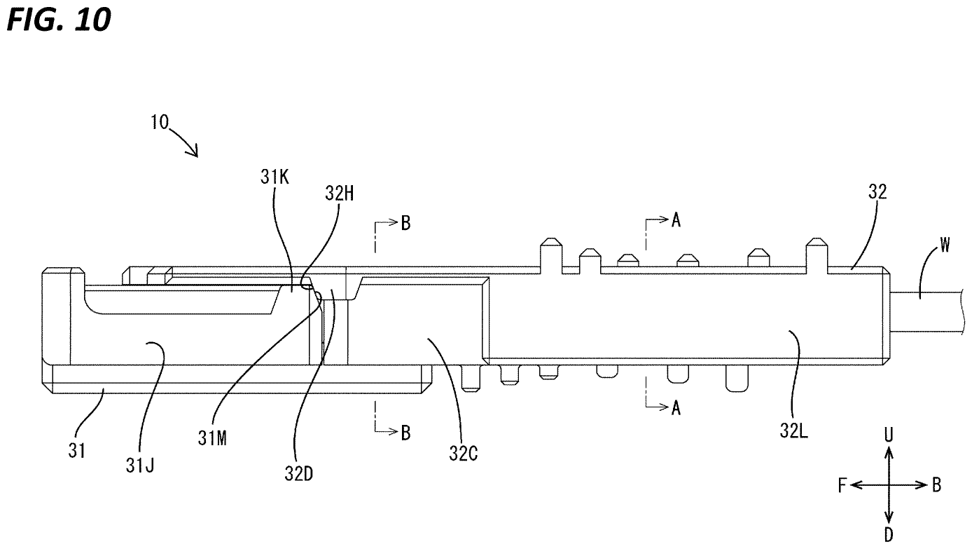

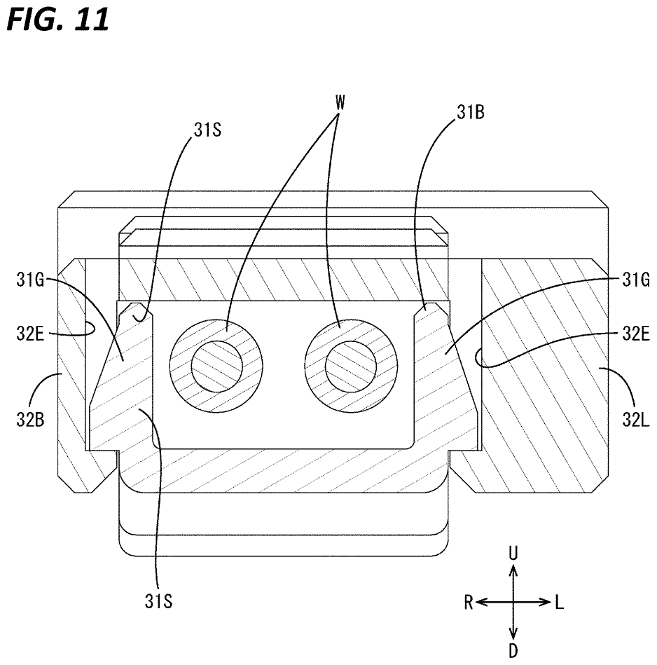

Next, an assembly procedure of the connector 10 is described. First, the two female terminal fittings 33 fixed to the wires W are accommodated into the accommodation chambers 31E of the accommodating member 31. At this time, the female terminal fitting 33 is accommodated into the accommodation chamber 31E in such a posture that the box portion 33A is adjacent to the back surface of the front wall portion 31C and the crimping portion 33B is arranged in a back part of the accommodating member 31. Subsequently, as shown in FIG. 10, the covering member 32 is put on and united with the accommodating member 31 from above by relatively arranging the covering member 32 with respect to the accommodating member 31 in the front-back direction such that the locked portion 32D is located behind the protrusion 31K. At this time, the first and second wall portions 32B, 32L are resiliently deformed outward in the lateral direction by contacting the lock projections 31G from above. If the lower ends of the respective lock projections 31G reach the insides of the respective locking recesses 32E, the first and second wall portions 32B, 32L resiliently return (see FIG. 11).

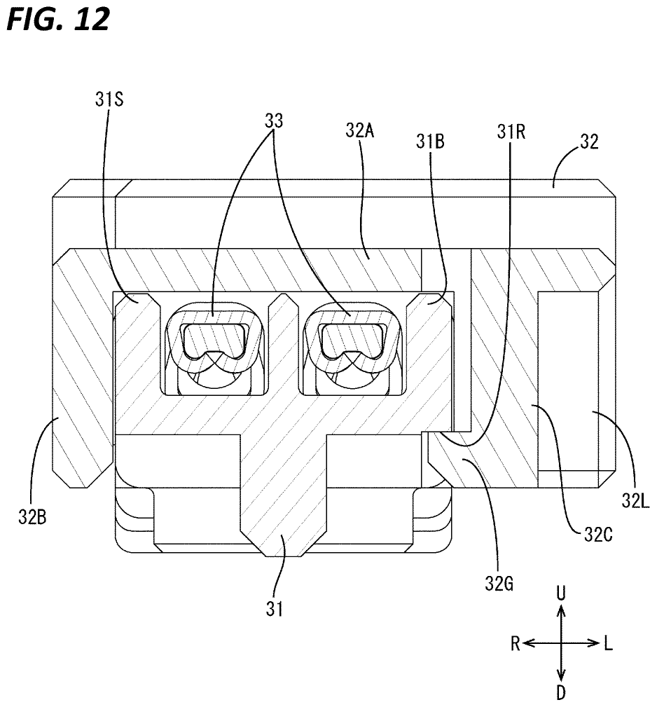

Along with this, the restricting portion 32G of the reinforcement wall portion 32C contacts the left side wall portion 31B, whereby the reinforcement wall portion 32C is resiliently deformed leftward. If the restricting portion 32G reaches a position below the guide portion 31R of the left side wall portion 31B, the reinforcement wall portion 32C resiliently returns (see FIG. 12). In this way, the restricting portion 32G is locked to the guide portion 31R from below. In this way, the covering member 32 is mounted on the accommodating member 31. With the covering member 32 mounted on the accommodating member 31, the front inclined surface 32H of the locked portion 32D is facing the back inclined surface 31M of the protrusion 31K (see FIG. 10). The plate portion 32A of the covering member 32 is facing the accommodating member 31 (see FIG. 12). Further, the reinforcement wall portion 32C is arranged behind the locking portion 31J (see FIG. 10). The position of the covering member 32 with respect to the accommodating member 31 at this time is a second position.

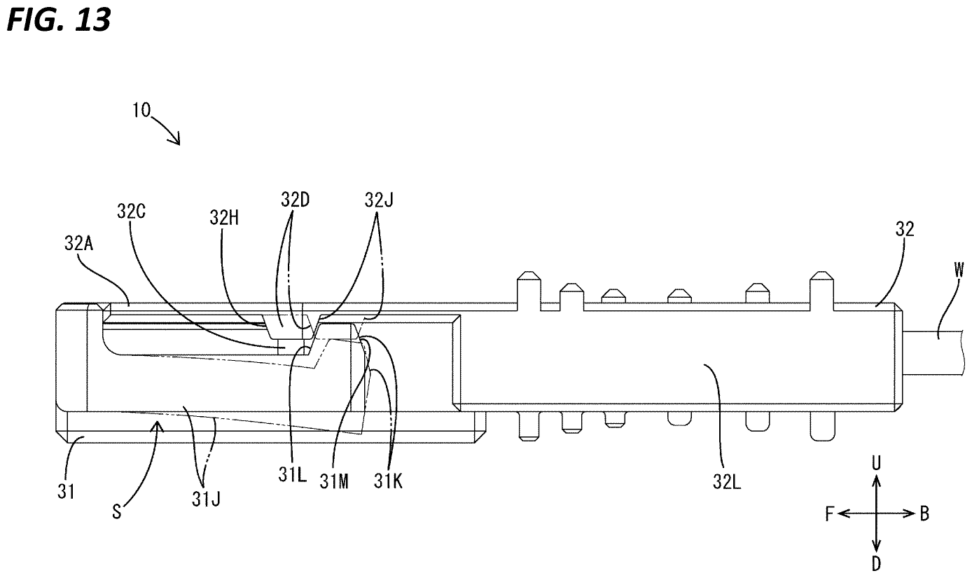

Subsequently, the covering member 32 is displaced forward to slide with respect to the accommodating member 31. Specifically, if the covering member 32 arranged at the second position is displaced forward with respect to the accommodating member 31 as shown in FIG. 13, the locked portion 32D is also displaced forward together with the covering member 32. In this way, the back inclined surface 31M of the protrusion 31K of the locking portion 31J is pressed downward by the front inclined surface 32H and the locking portion 31J is resiliently deformed downward (see the locking portion 31J shown by a two-dot chain line). A resilient deformation direction of the locking portion 31J by the locked portion 32D is a predetermined direction orthogonal to a sliding direction of the covering member 32 with respect to the accommodating member 31.

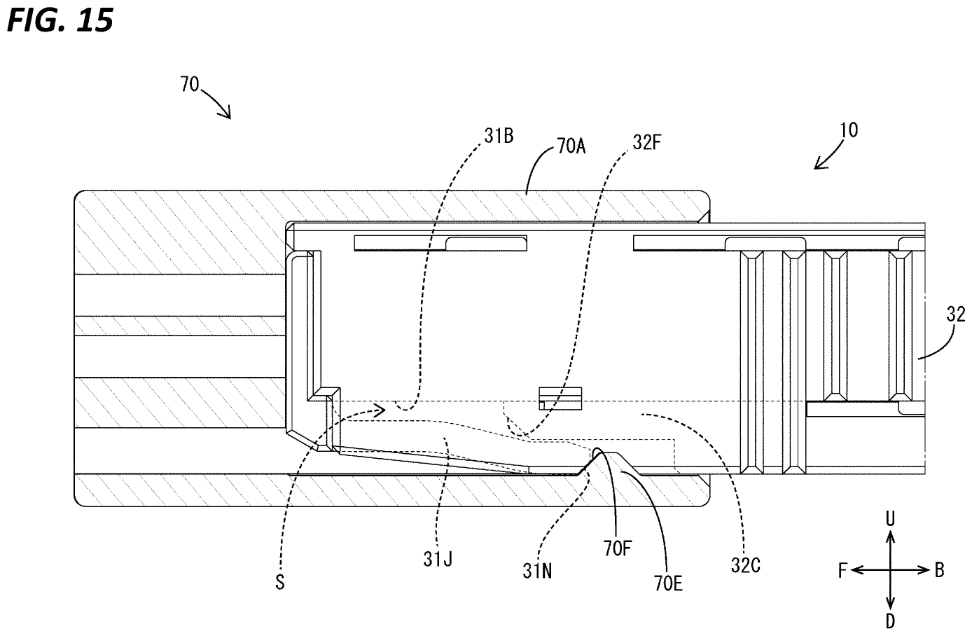

If the covering member 32 is further displaced forward with respect to the accommodating member 31, the locked portion 32D passes through the protrusion 31K and reaches a position forward of the protrusion 31K. In this way, the locking portion 31J resiliently deformed downward resiliently returns (see the locking portion 31n shown by a solid line). In this way, the back inclined surface 32J of the locked portion 32D faces the front inclined surface 31L of the protrusion 31K. In this way, the locking portion 31J locks the locked portion 32D. At this time, the reinforcement wall portion 32C enters the allowance space S from behind and is arranged to the right of a back part of the locking portion 31J (see FIG. 15). Since the reinforcement wall portion 32C is formed with the inclined surface 32F on a tip part to avoid the locking portion 31J (see FIG. 15), the reinforcement wall portion 32C easily enters the allowance space S. In this way, a displacement of the locking portion 31J into the allowance space S is restricted and a backward displacement of the covering member 32 is restricted. The position of the covering member 32 with respect to the accommodating member 31 at this time is a first position.

During a displacement of the covering member 32 between the first and second positions, the restricting portion 32G is slid in the front-back direction with respect to the guide portion 31R while constantly maintaining a state locked to the guide portion 31R (see FIG. 12). In this way, the restricting portion 32G restricts the separation of the plate portion 32A of the covering member 32 from the accommodating member 31 in an upward direction (opposite to the predetermined direction (downward direction)) with the locking portion 31J resiliently deformed downward by the locked portion 32D (see FIG. 12).

The covering member 32 is held at the first position with the locking portion 31J locked to the locked portion 32D. With the covering member 32 located at the first position, the reinforcement wall portion 32C is arranged in the allowance space S, thereby restricting the locking portion 31J from being resiliently deformed rightward (see FIG. 15). The covering member 32 at the first position covers the female terminal fittings 33 accommodated in the accommodating member 31 from above. At this time, the first wall portion 32B covers the entire right side wall portion 31S of the accommodating member 31 in the front-back direction and is locked to the right side wall portion 31S (see FIG. 11). The second wall portion 32L covers the back side of the left side wall portion 31B of the accommodating member 31 and is locked to the left side wall portion 31B (see FIG. 11). The locking portion 31J is arranged in front of the second wall portion 32L regardless of whether the covering member 32 is at the first position or at the second position (see FIGS. 10, 13). In this way, the assembly of the connector 10 is completed. The connector 10 having the covering member 32 arranged at the first position can be conveyed from a location where the assembly is performed to a location where the connector 10 is used (location where the mating connector 70 is connected).

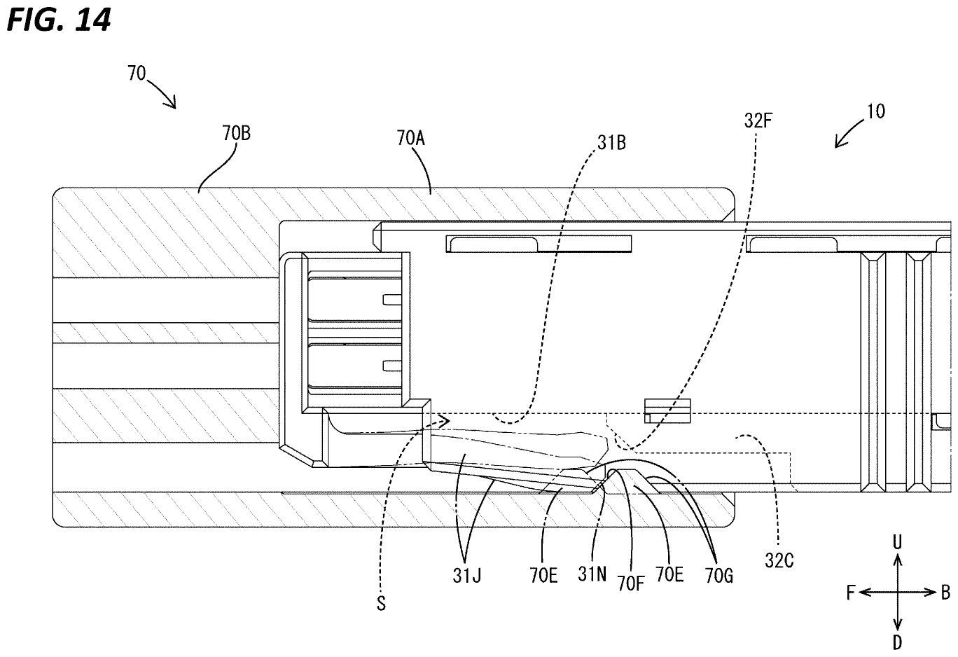

Subsequently, the connector 10 is connected to the mating connector 70. Specifically, the covering member 32 is moved backward and displaced from the first position to the second position with respect to the accommodating member 31. At this time, the front inclined surface 31L of the protrusion 31K of the locking portion 31J is pressed downward by the back inclined surface 32J, and the locking portion 31J is resiliently deformed downward. If the covering member 32 is further displaced backward with respect to the accommodating member 31, the locked portion 32D passes backward through the protrusion 31K and reaches a position behind the protrusion 31K (see FIG. 10). In this way, the locking portion 31J resiliently deformed downward resiliently returns (see FIG. 10). In this way, the front inclined surface 32H of the locked portion 32D faces the back inclined surface 31M of the protrusion 31K and the locking portion 31J is disengaged from the locked portion 32D (see FIG. 10). At this time, the reinforcement wall portion 32C is arranged outside the allowance space S (see FIG. 14). The covering member 32 is displaceable between the first and second positions. With the covering member 32 located at the second position, the reinforcement wall portion 32C is arranged outside the allowance space S, whereby the locking portion 31J is resiliently deformed and allowed to enter and be accommodated into the allowance space S. The covering member 32 is arranged at the second position with the locking portion 31J disengaged from the locked portion 32D.

Subsequently, the connector 10 is inserted into the receptacle 70A of the mating connector 70. Specifically, as shown in FIG. 14, the connector 10 is inserted into the receptacle 70A in such a posture that the front end of the connector 10 having the covering member 32 located at the second position faces the receptacle 70A.

If the connector 10 is inserted into the receptacle 70A, the locking portion 31J contacts the mountain-shaped portion 70E of the receptacle 70A and is pressed rightward by the back inclined surface 70G of the mountain-shaped portion 70E. In this way, the locking portion 31J is resiliently deformed rightward toward the left side wall portion 31B and enters the allowance space S (see the locking portion 31J shown by a two-dot chain line).

If the connector 10 is further inserted into the receptacle 70A, the front end of the connector 10 contacts the back surface of the back wall portion 70B. In this way, the mating terminals (not shown) are inserted into the box portions 33A and the female terminal fittings 33 and the mating terminals are brought into conduction. At this time, a back end part of the locking portion 31J rides forward over the mountain-shaped portion 70E and the locking portion 31J resiliently returns (see the locking portion 31J shown by a one-dot chain line). The left inclined surface 31N faces the front inclined surface 70F. In this way, the locking portion 31J is resiliently deformed by the mountain-shaped portion 70E, resiliently returns and locks the mountain-shaped portion 70E.

Subsequently, the covering member 32 is moved forward and displaced from the second position to the first position with respect to the accommodating portion 31. At this time, the back inclined surface 31M of the protrusion 31K of the locking portion 31J is pressed downward by the front inclined surface 32H and the locking portion 31J is resiliently deformed downward (see FIG. 13). If the covering member 32 is further displaced forward with respect to the accommodating portion 31, the locked portion 32D passes forward through the protrusion 31K and reaches a position forward of the protrusion 31K (see FIG. 13). In this way, the locking portion 31J resiliently deformed downward resiliently returns. In this way, the back inclined surface 32J of the locked portion 32D faces the front inclined surface 31L of the protrusion 31K (see FIG. 13).

At this time, as shown in FIG. 15, the reinforcement wall portion 32C is arranged in the allowance space S and arranged to the right of the back end part of the locking portion 31J. In this way, the covering member 32 is arranged at the first position to restrict the entrance of the locking portion 31J into the allowance space S. That is, if the connector 10 is inserted into the receptacle 70A, the locking portion 31J is held in a state locked to the mountain-shaped portion 70E in the receptacle 70A by the reinforcement wall portion 32C, and retains the connector 10 with respect to the receptacle 70A. In this way, the connection of the mating connector 70 and the connector 10 is completed.

In the case of separating the connector 10 from the mating connector 70, the covering member 32 is moved backward and displaced from the first position to the second position with respect to the accommodating member 31 and the reinforcement wall portion 32C is separated from the allowance space S (see FIG. 14). Then, the connector 10 is displaced in a direction separating from the receptacle 70A (backward). At this time, the left inclined surface 31N of the locking portion 31J is pressed rightward by the front inclined surface 70F of the mountain-shaped portion 70E (see FIG. 14). In this way, the locking portion 31J is resiliently deformed toward the left wall portion 31B and enters the allowance space S (see FIG. 14). If the connector 10 is further displaced in the direction separating from the receptacle 70A (backward), the front end part (base end part) of the locking portion 31J reaches the mountain-shaped portion 70E. Then, the locking portion 31J resiliently returns. In this way, the connector 10 can be separated from the mating connector 70.

Next, effects of this configuration are illustrated.

The connector 10 is provided with the accommodating member 31 for accommodating the female terminal fittings 33 and the covering member 32 for covering the female terminal fittings 33 accommodated in the accommodating member 31. The accommodating member 31 includes the locking portion 31J, and the covering member 32 includes the locked portion 32D to be locked by the locking portion 31J. The locking portion 31J is resiliently deformed in the downward direction (predetermined direction) by the locked portion 32D, resiliently returns and locks the locked portion 32D. The covering member 32 includes the restricting portion 32G. The restricting portion 32G restricts the separation of the covering member 32 from the accommodating member 31 in an upward direction opposite to the downward direction (predetermined direction) with the locking portion 31J resiliently deformed in the downward direction (predetermined direction) by the locked portion 32D. According to this configuration, by providing the covering member 32 with the restricting portion 32G, even if the locking portion 31J is resiliently deformed, the separation of the covering member 32 from the accommodating member 31 by a reaction force is restricted. Therefore, the plastic deformation of the covering member 32 can be prevented without increasing components.

The covering member 32 is displaceable between the first position and the second position with respect to the accommodating member 31. The locking portion 31J is configured to be resiliently deformed and resiliently return while the covering member 32 is displaced between the first position and the second position. The accommodating member 31 includes the guide portion 31R, to which the restricting portion 32G is locked from the downward direction (predetermined direction) side. The restricting portion 32G constantly maintains a state locked to the guide portion 31R while the covering member 32 is displaced between the first position and the second position. According to this configuration, the separation of the covering member 32 from the accommodating member 31 can be reliably restricted while the locking portion 31J is resiliently deformed and resiliently returns.

The covering member 32 includes the flat plate-like plate portion 32A facing the accommodating member 31 and the flat plate-like reinforcement wall portion 32C extending in the direction intersecting the plate portion 32A. According to this configuration, the deflection of the plate portion 32A can be prevented by reinforcing the plate portion 32A by the reinforcement wall portion 32C.

The plate thickness direction of the covering member 32 is oriented in the vertical direction, and the plate thickness direction of the reinforcement wall portion 32C is oriented in the lateral direction. The restricting portion 32G is provided on the lower end of the front end part of the reinforcement wall portion 32C, and the locked portion 32D projects downward from the plate portion 32A and is connected to the upper end of the front end part of the reinforcement wall portion 32C. According to this configuration, the locked portion 32D and the restricting portion 32G are both provided on the front end part of the reinforcement wall portion 32C, and the restricting portion 32G is arranged near the locked portion 32D, to which a reaction force of the resiliently deformed locked portion 31J is applied. Therefore, the separation of the plate portion 32A from the accommodating member 31 can be efficiently restricted.

The covering member 32 includes the first wall portion 32B extending long in the front-back direction and hanging down from the right end edge of the plate portion 32A with the plate thickness direction oriented in the lateral direction and the second wall portion 32L extending long in the front-back direction and hanging down from the left end edge of the plate portion 32A with the plate thickness direction oriented in the lateral direction. A length in the front-back direction of the second wall portion 32L is shorter than that of the first wall portion 32B. The first wall portion 32B entirely covers the right side wall portion 31S of the accommodating member 31 in the front-back direction and is locked to the right side wall portion 31S, and the second wall portion 32L covers the back side of the left side wall portion 31B of the accommodating member 31 and is locked to the left side wall portion 31B. The locking portion 31J is formed to extend in the front-back direction and arranged side by side with a front part of the second wall portion 32L, and the reinforcement wall portion 32C extends forward from the front end of the second wall portion 32L and is arranged to the right of the locking portion 31J. According to this configuration, since the locking portion 31J is provided in a front region of the accommodating member 31, the second wall portion 32L cannot be engaged with the front side of the left side wall portion 31B of the accommodating member 31. However, since the reinforcement wall portion 32C extends forward from the front end of the second wall portion 32L and is arranged to the right of the locking portion 31J, the reinforcement wall portion 32C can be arranged to the right of and adjacent to the locking portion 31J and reinforce the plate portion 32A (covering member 32) so as not to be separated from the accommodating member 31 in a region forward of the second wall portion 32L.

### Other Embodiments

The embodiment disclosed this time should be considered illustrative in all aspects, rather than restrictive. The scope of the present invention is not limited to the embodiment disclosed this time, but is represented by claims and intended to include all changes in the scope of claims and in the meaning and scope of equivalents.

Unlike the embodiment, a locked portion may be provided on a right wall of a receptacle, and a second locked portion and a locking portion may be provided on a right side.

Unlike the embodiment, a male terminal fitting including a tab may be used as a terminal fitting.

A resilient deformation direction of a locking portion by a locked portion is not limited to a downward direction, but may be an upward direction, a leftward direction, a rightward direction or the like.

### LIST OF REFERENCE NUMERALS

10 . . . connector
31 . . . accommodating member
31A . . . bottom wall portion
31B . . . left side wall portion
31C . . . front wall portion
31D . . . partition wall portion
31E . . . accommodation chamber
31F . . . retaining projection
31G . . . lock projection
31H . . . through hole
31J . . . locking portion
31K . . . protrusion
31L . . . front inclined surface
31M . . . back inclined surface
31N . . . left inclined surface
31P . . . right inclined surface
31Q . . . finger placing projection
31R . . . guide portion
31S . . . right side wall portion
32 . . . covering member
32A . . . plate portion
32E . . . first wall portion
32C . . . reinforcement wall portion
32D . . . locked portion
32E . . . locking recess
32F . . . inclined surface
32G . . . restricting portion
32H . . . front inclined surface
32J . . . back inclined surface
32K . . . finger placing projection
32L . . . second wall portion
33 . . . female terminal fitting (terminal fitting)
33A . . . box portion
33E . . . crimping portion
70 . . . mating connector
70A . . . receptacle
70B . . . back wall portion
70C . . . insertion hole
70E . . . mountain-shaped portion
70F . . . front inclined surface
70G . . . back inclined surface
S . . . allowance space
W . . . wire

1. A connector, comprising:
an accommodating member for accommodating a terminal fitting; and
a covering member for covering the terminal fitting accommodated in the accommodating member,
the accommodating member including a locking portion,
the covering member including a locked portion to be locked by the locking portion,
the locking portion being configured to be resiliently deformed in a predetermined direction by the locked portion, resiliently return and lock the locked portion,
the covering member including a restricting portion, and
the restricting portion restricting separation of the covering member from the accommodating member in a direction opposite to the predetermined direction with the locking portion resiliently deformed in the predetermined direction by the locked portion.

2. The connector of claim 1, wherein:
the covering member is displaceable between a first position and a second position with respect to the accommodating member,
the locking portion is configured to be resiliently deformed and resiliently return while the covering member is displaced between the first and second positions,
the accommodating member includes a guide portion to be locked by the restricting portion from the predetermined direction side, and
the restricting portion constantly maintains a state locked to the guide portion while the covering member is displaced between the first and second positions.

3. The connector of claim 1, wherein the covering member includes a flat plate-like plate portion facing the accommodating member and a flat plate-like reinforcement wall portion extending in a direction intersecting the plate portion.

4. The connector of claim 3, wherein:
a plate thickness direction of the plate portion is oriented in a vertical direction,
a plate thickness direction of the reinforcement wall portion is oriented in a lateral direction,
the restricting portion is provided on a lower end of a front end part of the reinforcement wall portion, and
the locked portion projects downward from the plate portion and is connected to an upper end of the front end part of the reinforcement wall portion.

5. The connector of claim 4, wherein:
the covering member includes a first wall portion extending long in a front-back direction and hanging down from a right end edge of the plate portion with a plate thickness direction oriented in the lateral direction and a second wall portion extending long in the front-back direction and hanging down from a left end edge of the plate portion with a plate thickness direction oriented in the lateral direction,
a length in the front-back direction of the second wall portion is shorter than that of the first wall portion,
the first wall portion entirely covers a right side wall portion of the accommodating member in the front-back direction and is locked to the right side wall portion,
the second wall portion covers a back side of a left side wall portion of the accommodating member and is locked to the left side wall portion,
the locking portion extends in the front-back direction and is arranged side by side with a front part of the second wall portion, and
the reinforcement wall portion extends forward from a front end of the second wall portion and is arranged to the right of the locking portion.
